(19) United States
(12) Patent Application Publication
(10) Pub. No.: US 2008/0286490 A1
(43) Pub. Date: Nov. 20, 2008

(54) Production of a Platinum-Free Chelate Catalyst Material as an Intermediate Product, and Further Processing Thereof to Obtain an Electrocatalytic Coating as a Final Product

(75) Inventors: Peter Bogdanoff, Berlin (DE); Sebastian Fiechter, Berlin (DE); Iris Herrmann, Berlin (DE)

Correspondence Address: DARBY & DARBY P.C., P.O. BOX 770, Church Street Station, New York, NY, 10008-0770, US

(73) Assignee: HAHN-MEITNER-INSTITUT BERLIN GMBH, Berlin (DE)

(21) Appl. No.: 11/816,688

(22) PCT Filed: Feb. 20, 2006
(86) PCT No.: PCT/DE2006/000326

§ 371 Date: Apr. 29, 2008

(30) Foreign Application Priority Data
Feb. 20, 2005 (DE) 10 2005 008 338.2

(51) Int. Cl. H05H 1/24; B01J 19/08

(52) U.S. Cl. 427/569; 204/157.63

(57) ABSTRACT

A method for preparing a platinum-free chelate catalyst material as an intermediate product for selective electrocatalytic reduction of oxygen includes performing a low-temperature plasma treatment on a powdery form of the transition-metal chelate in a plasma reactor chamber having an inert plasma gas disposed therein. A plasma power, a plasma gas pressure, a plasma initialization and a treatment time of the low-temperature plasma treatment are selected so that molecules of the transition metal chelate are fragmented in the plasma and cross-link in a subsequent chemical reaction so as to form a carbon matrix and retain a basic chelate structure in a surrounding of the transition metal.

### CROSS REFERENCE TO PRIOR APPLICATION

This is a U.S. National Phase application under 35 U.S.C. §371 of International Application No. PCT/DE2006/000326, filed Feb. 20, 2006 and claims the benefit of German Patent Application No. 10 2005 008 338.2, filed on Feb. 20, 2005. The International Application was published in German on Aug. 24, 2006 as WO 2006/086979 under PCT Article 21 (2).

### FIELD OF THE INVENTION

The present invention relates to a method for preparing a platinum-free chelate catalyst material as an intermediate product for the selective electrocatalytic reduction of oxygen, having a porous, conductive carbon matrix containing embedded, electrochemically active centers of a transition-metal chelate, and to a method for further processing the intermediate product to obtain an electrocatalytic coating as a final product on a substrate, as well as to an application of the final product.

### BACKGROUND

Platinum-free chelate catalyst material for the electrocatalytic reduction of oxygen can be used as cathode material in electrochemical cells, so-called fuel cells (alkaline and acid-based fuel cell, hydrogen- or methanol-operated polymer electrolyte membrane fuel cell). When methanol is used as fuel for fuel cell operation (in the case of a direct-methanol fuel cell), cathode poisoning occurs when platinum is used as a catalyst. In contrast, platinum-free chelate catalyst material behaves selectively and is methanol-tolerant. Moreover, catalyst material of this kind can be used as a gas sensor for detecting oxygen in gases. The starting material used for the platinum-free chelate catalyst material forms organometallic complexes, so-called transition-metal chelate molecules (for example, phthalocyanines, porphyrins, tetraazaannulenes). A transition-metal chelate molecule is a complex compound which has a central metal ion of a transition metal surrounded by a ring of one or more atoms or ions, forming a plurality of covalent bonds.

The electrochemical activity of chelate catalyst materials used for the selective reduction of oxygen is already known since 1964. It has been ascertained that a heat treatment in inert atmosphere up to temperatures of 600° C. results in improved activity and stability. The technique has been derived therefrom, on the one hand, of first adsorbing the untreated chelate molecule onto a conductive, highly porous carbon black support material and of subsequently converting the same into the stabilized product in a high-temperature reaction. On the other hand, techniques are also carried out employing an in-situ preparation without a carbon black support material, in which a metal salt additive decomposes in the heat treatment into a metal or its oxide. However, the reaction batch is treated again in a high-temperature process. This method is known from the International Patent Application WO 03/004156 A2. Besides a first transition metal, the chelate catalyst material it describes having a porous, conductive carbon matrix containing embedded, electrochemically active centers of a transition-metal chelate also has a nitrogen-containing organometallic transition complex including a second transition metal that differs from the transition metal, as well as a chalcogen component. It is possible in this manner to combine the advantages derived from different transition metals and from the chalcogens, as electrically conductive compounds. In addition, the first transition metal, in the form of a salt, is used as a filler during formation of the carbon matrix, imparting ultra-high porosity thereto due to the foaming action caused by the thermal decomposition of the salt.

The structure of the chelate catalyst treated in a high-temperature process is examined and discussed in numerous publications. In the case of a preparation using a metal salt, the source of the electrochemical activity is attributed to the transition metal ion that is coordinated to two nitrogen atoms which are attached to four carbon atoms. At higher temperatures (above 800° C.), it could be demonstrated that the nitrogen atmosphere is disturbed and that the transition metal is reduced to elementary metal. A decline in the electrochemical activity in parallel thereto could be observed during this conversion. The chelate catalyst differs from a commercial catalyst, such as the platinum catalyst, for example, in that it is not composed of fine metal particles, but rather of molecule-integrated catalyst centers in a carbon matrix.

In accordance with the International Patent Application WO 03/004156 A2, it could also be demonstrated that a conductive carbon matrix (graphite), in which the described catalyst centers are embedded, is formed from the organic ring structure of the chelate molecule during the high-temperature reaction. On the one hand, the conductivity of the carbon matrix ensures the rapid electron transport from the rear contact of the electrode to the catalyst centers. On the other hand, because of the delocalized π-electrons, the carbon matrix acts as a rapid electron donor for an electron transfer at the catalyst center. The catalyst centers are thereby stabilized and become highly reactive because four electrons are able to be transferred rapidly enough to the center. This improved coupling of the catalyst centers to the electron transport promotes an efficient oxygen reduction, so that higher current densities are obtained.

However, the chelate catalyst material known from the related art having chelate molecules adsorbed onto a carbon black support material and treated in a high-temperature process, exhibits unsatisfactory catalytic performance characteristics. This is due to the disadvantageous surface quality of the material. It could be demonstrated by Bogdanoff et. al., (J. New Materials and Electrochemical Systems, 7, 85-92 (2004)) that, with the increase in the concentration of the chelate molecules on the carbon black support material (and a subsequent treatment in the high-temperature process), a reduction in the low-porosity specific surface area is observed. Before decomposing, the organic molecules fuse together, forming a compact product. Catalytic centers are located inside of the reaction layer and are, therefore, not able to take part in the oxygen reduction. If the chelate molecule is treated without the use of a carbon black support material in order to obtain a higher center density in the high-temperature reaction, then the disadvantage of this process becomes even more clearly apparent. The sintering process produces 20 μm-sized particles which have a solid, glassy surface.

Thus, it is evident that there is a need for novel methods for preparing platinum-free chelate catalyst material that will avoid this type of sintering and the associated reduction in catalytic activity. Therefore, the general trend in related art catalyst preparation methods is away from traditional preparation methods. Innovative methods, such as photochemical processes, for example, plasma and ultrasound treatment, are gaining new significance and are attracting the attention of the scientific community because they allow a selective conversion of precursor material into nm-scale catalyst material. Therefore, several publications already describe using a plasma treatment to finely disperse catalyst particles (metals and/or their oxides) over a support material. Dittmar (Dissertation “Präparation von CrOx-Trägerkatalysatoren durch ein Mikrowellenplasma-gestltztes Verfahren und deren Charakterisierung”, Berlin 2002, in particular Chapter 3.1) can be cited here as an example. In this context, an organic Cr complex is deposited onto the surface of a support material. The organic complex is broken down by the plasma treatment in the oxygen-containing plasma, forming metal oxide particles. These catalysts are used in the dehydrocyclization of n-octane to form alkyl aromatics.

Another example can be inferred from the German Patent Application DE 199 53 110 A1 which describes likewise adding organometallic complexes (and/or at least one alcoholate containing such a metal) into a plasma reactor. In the subsequent plasma treatment using an oxygen-containing plasma, these complexes react to form their metal oxide particles or, when sulfur is added, to form their metal sulphides. These semiconductors are photocatalytically active. In parallel to the formation of the photocatalyst, harmful substances are added into the reactor and are converted into intermediate products by the plasma treatment being carried out. The photocatalyst formed accelerates the breakdown of these intermediate products, allowing the harmful substances to decompose fully into less toxic substances. A method is also known from the German Patent DE 41 07 595 C2 that describes producing a catalyst having platinum, palladium or alloys thereof using plasma spraying and/or flame spraying processes.

Moreover, numerous publications discuss treating organic molecules in plasma. From Osada et al. (“Preparation and Electrical Properties of Polymeric Copper Phthalocyanine Thin Films by Plasma Polymerization,” J. Appl. Phys., 59 (5), p. 1776-1779 [1986]), it is known for the first time to apply the plasma treatment to copper phthalocyanine in order to cross-link the same to obtain a thin polymer film. Low plasma powers were used (max. 100 W 60 s) to prevent destruction of the ring structure. In addition, the monomers were heated to allow the phthalocyanine molecules in the gaseous state to rise and react in the plasma. It is also known, in turn, from Inagaki et. al. (“Plasma Polymer Thin Films of Zinc Phtalocyanines for NO₂ Gas Sensor Device,” Polymer Bulletin, 36, pp. 601-607[1996]), to produce a thin, semiconductive polymer film from zinc phthalocyanine vaporized at 330° C. using a low plasma power (25 W 15 min in argon plasma). When gas molecules to be detected are adsorbed onto the polymer film, the conductivity of the film changes. However, these films exhibit low electrical conductivity properties that are not selective.

Nakamura et al. (“Plasma Polymerization of Cobalt Tetraphenylporphyrin and the Functionalities of the Thin Film Produced,” Thin Solid Films, 345, 99-103, [1999]) discusses using the known plasma polymerization method to produce polymer films from a cobalt tetraphenylporphyrin (CoTPP). In the process, CoTPP is heated to 390° C., causing it to vaporize. The CoTPP gas produced is subsequently treated in an inert argon plasma (10 to 100 W, 10 Pa Ar, 150 s). The plasma action causes fragmentation of the monomer gas. The thus formed radicals are able to react with one another. In the process, larger agglomerates condense on the substrate surface and undergo polymerization and cross-linking under bombardment by other particles from the plasma.

Finally, in an Experts' Report on “Wissenschaftlichtechnische Analyse von neuartigen Brennstoffzellen für maritime Anwendungen, vorrangig für den Unterwassereinsatz”, time period of study: October-December 2002, AMT Analysentechnik GmbH, available on the Internet at www.wti-mv.de/expertisen/exp_amt.pdf, status Feb. 9, 2005, under point 6, a plasma-supported fixation of organometallic catalysts is mentioned in connection with an investigation of different catalyst types. However, further details cannot be inferred from the Experts' Report.

Related-art publications are also known which discuss producing coatings from catalyst material. Typically, simple or patterned substrates are coated in order to obtain different electrocatalytically active electrodes. A typical method for producing gas-diffusion electrodes entails pressing or spreading processes. In this connection, a previously prepared catalyst powder is placed in suspension with a proton-conducting polymer and is subsequently applied to the membrane or carbon paper. A first automated preparation technique was developed from the once conventional method of producing a gas-diffusion electrode by hot or cold pressing. In this connection, catalyst powder is sprayed onto the membrane and is subsequently hot-pressed using carbon paper. Numerous methods having similar principles of operation are implemented which make possible a high dispersion of the catalyst particles during preparation of the gas-diffusion electrodes. These include, the electrospray technique, for example. In this context, the catalyst ink is exposed to an electric field, producing a mist of charged catalyst droplets. The solvent vaporizes during the flight phase. Finally, finely dispersed catalyst particles are precipitated onto the preselected carbon paper.

European Patent EP 0 830 464 B1 describes producing an electrode layer by high-speed oxygen combustion, plasma spraying, wire or powder flame spraying, electric arc spraying and explosion spraying. In this connection, an active cathode material (inorganic oxides and salts, for example, silver vanadium oxide, CuS) is brought to the molten and/or plasticized state by high heat input (1650° C. to 2480° C.), scattering the material. The scattered particles are subsequently deposited onto a substrate. The layer formed has a roughness in the μm range and a porosity of approximately 2 to 17% by volume.

Although these automated preparation processes have paved the way from the factory to industrial production of gas-diffusion electrodes, the methods mentioned are disadvantageously characterized by an ex-situ preparation of the catalyst and a high loss of catalyst material during the process. To overcome these disadvantages, methods have been developed which provide for precursors to be scattered, converted into an active material, and subsequently deposited onto a substrate layer that defines a structure. These also include the vacuum deposition methods. For example, to produce platinum electrodes, a platinum precursor is vaporized and decomposed in a reactor under oxidative conditions and high pressure to yield platinum. A deposition temperature of approximately 350° C. to 400° C. is used. In addition, carbon electrodes are also produced using vacuum deposition methods. To this end, reactive acetylene gas (produced from an H₂ plasma treatment) in a reaction chamber is directed along a substrate layer. The reactive molecules are precipitated onto a steel substrate layer and evolve into carbon nanotubes under the specified synthesis conditions (600° C. to 800° C., 1-10 Torr acetylene gas). However, in the described methods, it is only by adding heat that the active material is able to be produced from the precursor during the electrode preparation process.

Furthermore, electrodeposition methods are also employed to produce electrodes. For example, the substrate can be a carbon nanotube electrode produced by chemical vacuum deposition that takes on the function of a cathode in an electrochemical cell. An acid platinum solution is used as electrolyte. The platinum ions of the electrolyte are reduced at approximately −0.25 V(SCE) on the carbon nanotube surface to yield metallic platinum particles. Although the active catalyst particles are located exclusively on the electrochemically accessible surface, and a high dispersion is achieved, thereby creating a suitable bounding surface for the electrochemical processes to occur later, the catalyst particles produced in this process are still too large (150 nm) to permit an effective catalysis.

A newer method for producing coatings is the sputtering method, which allows nanoscale particles to be produced. In this connection, high-energy ions are produced from a low-energy plasma. By bombarding a sputtering target with these high-energy ions at high kinetic energy, individual atoms or molecules are released from the sputtering target and subsequently redeposited as a thin layer onto a substrate. Sputtering technology is also used to produce catalysts. The sputtering method permits an in-situ catalyst preparation and a finely dispersed deposition of the catalyst particles formed which are a few nm in size. Hirano et al (“High Performance Proton Exchange Membrane Fuel Cells with Sputter-Deposited Pt Layer Electrodes,” Electrochimica Acta, vol. 42, no. 10, pp. 1587-1593, 1997) describes producing platinum catalyst gas-diffusion electrodes for the fuel cell, for example. Platinum atoms are knocked out of a platinum target in response to application of a plasma. These platinum atoms migrate toward the gas-diffusion electrode, so that finely dispersed catalyst centers, in the form of nm-scale platinum metal particles, form on the electrode.

The previously described methods are all based on the process steps used in scattering the particles and the subsequent deposition thereof on a substrate. A fine dispersion up to the nanometer range can be achieved in this manner. However, there is no discussion of a simultaneous chemical reaction and creation of a new substance having particles in the nanoscale range.

Sputter deposition processes are also utilized to produce thin yttrium-stabilized zirconium oxide electrodes for the solid oxide fuel cell. In this connection, a target made of a yttrium-zirconium composite and of a reactive oxygen-containing plasma is used which incorporates oxygen atoms into the deposited yttrium-zirconium layer. However, in the case of this so-called reactive sputtering, only one radical formation takes place at the deposited layer, so that foreign atoms are able to be intercalated in and bound to the layer.

### SUMMARY OF THE INVENTION

Therefore, it is an object of the present invention to provide a method for preparing a platinum-free chelate catalyst material with improved catalyzing capacity in such a way that the particles are prevented from sintering together during the reaction. It is intended, additionally and alternatively to provide a product made of nm-scale particles having a highly catalytically active surface. It is also alternatively intended that, from this product, a final product in the form of an electrocatalytic coating, particularly suited for gas-diffusion electrodes, be obtainable as an intermediate product in a simple, efficient, and cost-effective manner.

The method according to the present invention for preparing a platinum-free chelate catalyst material for the selective electrocatalytic reduction of oxygen, having a porous, conductive carbon matrix containing embedded, electrochemically active centers of a transition-metal chelate is characterized by a low-temperature plasma treatment of the powdery transition-metal chelate in a plasma reactor chamber containing an inert plasma gas, the plasma power, plasma gas pressure, plasma initialization and treatment time being selected in such a way that the molecules of the transition-metal chelate are fragmented in the plasma and cross-link in a subsequent chemical reaction in such a way that, on the one hand, the carbon matrix is formed; on the other hand, however, the basic chelate structure is retained in the surroundings of the transition metal.

### BRIEF DESCRIPTION OF THE DRAWINGS

The method according to the present invention for preparing a platinum-free chelate catalyst material as an intermediate product and the further processing thereof into an electrocatalytic coating as a final product, and the use thereof in a gas-diffusion electrode for the selective electrocatalytic reduction of oxygen are clarified in greater detail in the following with reference to the drawings, which show:

FIG. 1 a Raman spectrum of a CoTMPP/KBr specimen at a plasma power of 80 W;

FIG. 2 a Raman spectrum of a CoTMPP/KBr specimen at a plasma power of 150 W;

FIG. 3 a Raman spectrum of a CoTMPP/KBr specimen at a plasma power of 250 W;

FIG. 4 a Raman spectrum of a CoTMPP/KBr specimen at a plasma power of 400 W;

FIG. 5 a comparison of a plasma-treated and of a pyrolyzed CoTMPP/KBr specimen;

FIG. 6 a diagram showing current density behavior;

FIG. 7 a diagram showing particle size distribution;

FIG. 8 a comparison of the Raman spectra of the original precursor (CoTMPP) and of a specimen from the combined sputtering plasma process;

FIG. 9 two REM photographs of a substrate prior to and subsequently to the combined sputtering plasma process (magnification 50,000 times, 2V deflection voltage); and

FIG. 10 a REM photograph of a substrate subsequently to implementation of the combined sputtering plasma process (magnification 200,000 times, 2V deflection voltage).

### DETAILED DESCRIPTION

By employing the plasma treatment, during which a great deal of electronic, but only little thermal energy is transferred to the molecules (this is characteristic of a low-temperature plasma, also referred to as a nonthermal plasma, since only the light electrons are a few ten thousand degrees hot, however, the ions and neutral particles are virtually at room temperature), a chelate catalyst material may be obtained, which, due to negligible sintering and thus production of nanoscale particles having a large, catalytically active surface, has a higher activity for the electrocatalytic reaction of the oxygen reduction than conventional thermal treatments. A chelate catalyst material made of an electrically conductive carbon matrix having embedded, electrochemically active centers is prepared by the method according to the present invention. The plasma treatment controls the fragmentation of the chelate molecules as starting material, the cross-linking of these fragments as a chemical reaction in the plasma, the inert plasma gas remaining completely uninvolved in the reaction, and controls the final carbon matrix formation. In the process, the basic chelate structure is retained in the surroundings of the metal ion.

The method according to the present invention is distinguished from Ditmar, named above, and from the prior printed publications, German Patent Application DE 199 53 110 A1 and German Patent DE 41 07 595 C2, in that it is not intended that metal particles, respectively oxides or sulphides thereof, be formed in the plasma treatment with the participation of a chemically reactive plasma gas. Rather, in the case of the present invention, the organometallic complex (chelate molecule) is converted in the plasma in such a way that a carbon matrix having embedded, electrochemically active centers (metal ion coordinated by nitrogen atoms) is obtained. As previously mentioned, the electrochemical activity of the catalyst is reduced when metal particles or oxides thereof are formed from the organometallic complex. Therefore, the method according to the present invention succeeds in maintaining the internal chelate structure and in preventing a reduction to metal particles, but, at the same time, in decomposing the molecule, so that a carbon matrix is formed. In response to the plasma treatment, the chelate molecule is converted into a conductive, carbon-based, electrochemically active material. Through the use of an efficient low-temperature, high-power plasma to produce a high depth of penetration, fragments of the chelate molecule are formed which are linked in a subsequent chemical reaction to form a conductive carbon matrix.

It is in the parameterization that the method according to the present invention differs fundamentally from Osada et al., Inagaki et al., and Nakamura et al. with respect to producing a polymer film from organometallic complexes using a plasma treatment. In the known methods, the low plasma powers (less than 250 W) to be expended, in combination with the short treatment times, ensure that the molecules are not destroyed; instead they are radicalized, so that polymerization takes place. The repeating units of the polymer films (thus, in accordance with the UV/VIS analysis discussed in publication III) are retained in the process. In the method according to the present invention, because of cleavage of the molecular bonds, the plasma treatment using a high plasma power leads to a carbon matrix (graphite), which has a substantially higher conductivity than the untreated starting material. In addition, the plasma-treated product according to the present invention is electrochemically active for the oxygen reduction. This makes it possible to substitute the expensive high-temperature process which is required under the related art in order to treat the chelate molecules on a carbon black support material and which—as described in Bogdanoff et al.—leads to a sintering of the molecules.

In order to prepare a platinum-free chelate catalyst material with a high catalytic activity, the method according to the present invention encompasses a plasma treatment that is carried out at a high plasma power and a low plasma temperature. The desired fragmentation of the chelate molecules and the restructuring thereof into the desired graphite matrix having catalytically active centers is accomplished by the length of the treatment time, the high plasma power, and the associated high penetration depth of the plasma into the starting material to be treated. From these targeted goals, the range of parameterization of the method according to the present invention is revealed to one skilled in the art. In particular, on the basis of tests conducted, it turns out that it is especially beneficial to use a plasma gas pressure in the plasma reactor chamber within the range of 10 Pa, a plasma initialization in response to frequency excitation within the radio frequency range, a plasma power of more than 250 W, and a treatment time of the powdery transition metal chelate of between 5 and 20 minutes. In addition, carbon may be used as a substrate medium for the powdery transition metal chelate, which has the effect of promoting the formation of the carbon matrix. In contrast, however, the use of unsupported powdery transition metal chelate provides the advantage of a higher center density and thus of a further enhanced catalytic activity of the chelate catalyst material.

Usable starting materials for the method according to the present invention are already known from the method for preparing a platinum-free chelate catalyst material, as described in the International Patent Application WO 03/004156 A2. The transition metal may preferably be a group VIII transition metal, in particular cobalt or iron. The nitrogen-containing organometallic transition metal complex may advantageously be a metalloporphyrin. It may contain cobalt or iron and, in particular, be formed as cobalt tetramethoxyphenylporphyrin (CoTMPP) or iron tetramethoxyphenyl porphyrin chloride (FeTMPP—Cl). Metalloporphyrins exhibit exceptional starting material properties because they have the structure of a catalytic center that is composed of an active transition metal ion coordinated by four nitrogen bonds. The substituents of the porphyrin molecule contribute in the cross-linking reaction to a conductive carbon matrix, so that a good surface accessibility and catalysis effect are achieved. The metalloporphyrin combines the nitrogen and the carbon donors.

The above described method according to the present invention leads to the production of a platinum-free chelate catalyst material that is characterized by high catalytic activity and may be provided as an intermediate product for producing catalytically active coatings as a final product on a substrate. In the further processing of the intermediate product into a final product, a new preparation method is provided for producing a catalytically active coating which is then used, for example, in a gas diffusion electrode. An electrode of this kind having a coating of a platinum-free chelate catalyst material for the selective electrocatalytic reduction of oxygen, having a porous, conductive carbon matrix containing embedded, electrochemically active centers of a transition-metal chelate on a substrate, may be produced by a plasma treatment of the type previously mentioned—in all design variants—in combination with a sputtering treatment. The preparation of a coating includes
a first low-temperature plasma treatment of a sputtering target made of the transition-metal chelate in a plasma reactor chamber containing an inert plasma gas having such a selection of plasma power, plasma gas pressure and plasma initialization that molecules of the transition metal chelate are released and pass over into the plasma without being fragmented; and
a second low-temperature plasma treatment of the released, unfragmented molecules of the transition metal chelate that have passed over into the plasma, in a plasma reactor chamber containing an inert plasma gas having such a selection of plasma power, plasma gas pressure, plasma initialization and treatment time that the molecules of the transition metal chelate are fragmented in the plasma, and the fragments cross-link in a subsequent chemical reaction in such a way that, on the one hand, the carbon matrix is formed, on the other hand, however, the basic chelate structure is retained in the surroundings of the transition metal,
   the first and the second plasma treatments being carried out in a process that alternates once or a plurality of times between a shared plasma reactor chamber, featuring a protection of the sputtering target during the second plasma treatment, or in parallel in separate plasma reactor regions; and
deposition of the platinum-free chelate catalyst material prepared in the second low-temperature plasma treatment, onto the substrate.

Employing this method according to the present invention, a final product in the form of a coating is obtained from the intermediate product in the form of a powdery (crystalline), carbonized, platinum-free chelate catalyst material. In this context, the structure of the intermediate product (special material combination having a spongy, highly porous surface) is retained in the final product, so that the advantageous catalytic activity is also retained due to the large surface area of the catalytically active material in the coating.

The combined method may be carried out in alternating or in two successive process stages. In the case of the alternating process sequence, a low-temperature plasma is differently parameterized in alternating succession (for example at a frequency in the kHz to the mHz range), so that two different plasma powers are reached in an alternating process (low plasma power, preferably below 150 W for the sputtering process and high plasma power of preferably above 250 W for the plasma process). When producing the high plasma power, the sputtering target may be suitably covered to ensure that it is not damaged. In the case of the parallel treatment in two different reactor regions, a changed reactor structure results. The particles sputtered in the first low-temperature plasma treatment (treatment time relatively short, long enough for molecules to be sufficiently available in the plasma) are then directed within the reactor into a second low-temperature plasma (two-zone plasma), whose parameters may be adjusted independently of the first plasma. In the second low-temperature plasma treatment, the previously sputtered molecules are then converted at high plasma powers into the pulverized (crystallized), carbonized chelate catalyst material. The carbonization process may then be selectively controlled independently of the sputtering process, as a function of the operating parameters and the expansion of the second plasma. The process stage concludes with the substrate, which is positioned outside of the plasma and upon which the nanoscale catalyst particles produced in the second plasma are deposited as a nanoporous coating.

One modification of the previously described preparation method provides that the substrate be placed within the plasma for the second low-temperature plasma treatment. In this manner, the thereby formed CoTMPP molecules contained in the plasma are deposited as a thin layer directly onto the substrate. Generally, the thickness and the structure of the catalytically active coating to be obtained as a final product may be controlled as a function of the loading and the process parameters of the processes. In addition, a polymer electrolyte membrane, for example Nafion, upon which the prepared, platinum-free chelate catalyst material is deposited, may also be utilized as a substrate. By employing known and established methods, the thus produced catalytic layers may be utilized for producing membrane electrode assemblies (in short: MEA) for PEM fuel cell technology.

The described method for producing the final product according to the present invention differs already from Hirano et al. in that it provides for the plasma to be used exclusively for producing finely dispersed metal particles. In the combined preparation method according to the present invention, the first plasma is used for providing the high-energy gas ions and the second plasma for preparing the chelate catalyst material, as well as for depositing the same onto the electrode surface. In addition, in contrast to the plasma polymerization discussed in Nakamura et al., as described above, the combined method for producing an electrocatalytic coating in accordance with the present invention provides for the scattering of the starting material in the sputtering target to take place in a sputtering process without adding heat.

The described combination of the two methods according to the present invention allows a coating that has a novel type of highly porous structure and thus that is highly catalytically active to be obtained in the surface in a simple and cost-effective manner. In particular, all of the method steps included for producing the coating may also be integrated into one automated in-line process, allowing large quantities of suitable electrocatalytic electrodes to be produced quickly, at high quality and, nevertheless economically, without entailing substantial personnel costs. This applies, in particular, when the electrodes are designed as gas-diffusion electrodes which are used to an increasing degree in the selective reduction of oxygen.

### Plasma Treatment

The starting material is prepared as follows: 0.264 g cobalt tetramethoxyphenyl porphyrin (in the following, CoTMPP, from ACROS) are dissolved in 200 ml of tetrahydrofurane (in the following THF). 1,051 g of “black pearls” (highly porous carbon support 1,475 m²/g) are likewise slurried in 200 ml of THF. The two batches are intermixed and subsequently treated for 20 min in the ultrasonic bath. The solvent is subsequently removed in the rotary evaporator. No segregation of the two constituents is observed in the process. Large granulates form, which are subsequently comminuted in a beater mill for 5 s. The specimen are placed in a vacuum for several hours because it is not possible to rule out occlusion of residual THF within the pores.

The plasma treatment is carried out in a plasma vibration reactor. For this purpose, 0.5 to 0.8 g of the starting material placed on a specimen holder plate are loaded into the reactor chamber. Radio frequency excitation (13, 56 MHz) is used to initialize the plasma. The reactor chamber contains 10 Pa argon as inert plasma gas. The specimen are thoroughly intermixed in the reactor chamber in response to vibration of the specimen holder plate, exposing each particle to the plasma. Using a high plasma power (greater than 250 W) and a treatment time of 5 to 40 min, the CoTMPP is effectively converted to carbon-based chelate catalyst. In this practical example, the starting material is treated for 20 min at 400 W.

As a comparison, the related art preparation process using a high-temperature treatment provides for heating the starting material in a flow-through oven (110 ml/min argon) for 2 h at 450° C., as well as subsequently for 1 h to 750° C. Once it has cooled, the material may be used.

### CoTMPP Carbonization Process During the Plasma Treatment

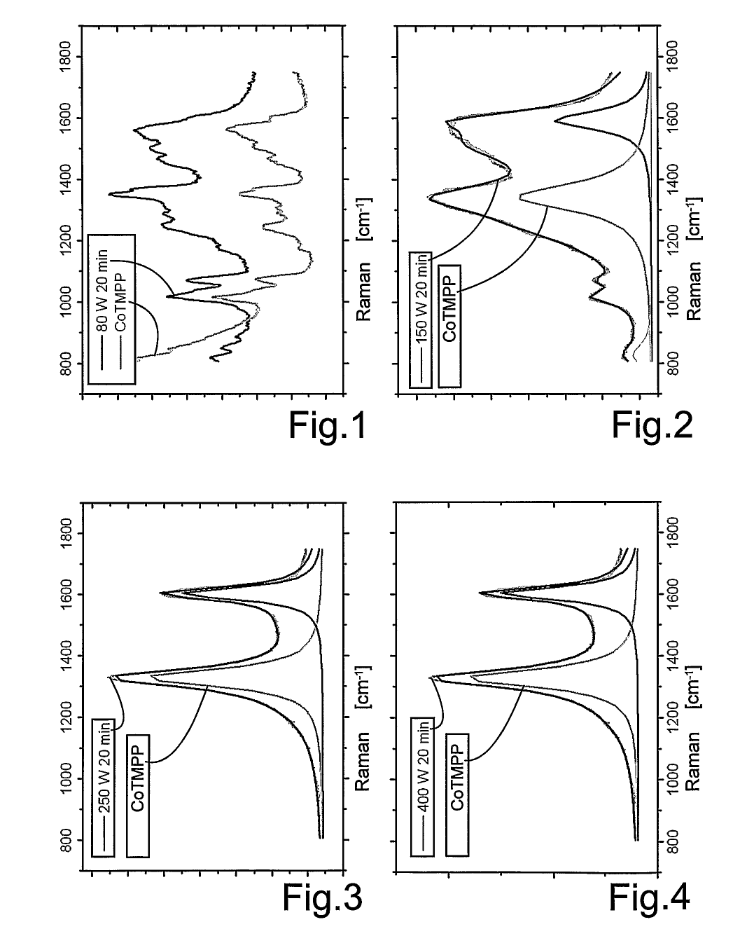

The use of the plasma-based method according to the present invention for converting CoTMPP, for example, into a carbon matrix having integrated catalytically active centers as an intermediate product for obtaining catalytically effective coatings raises the question of whether a structure is obtained similar to that produced using conventional pyrolysis. Therefore, to monitor the formation of the catalytically active substance, CoTMPP was applied to a carbon-free support material (potassium bromide KBr powder) and treated in the plasma at different powers. Because the KBr is Raman-inactive, the carbons formed from CoTMPP may be structurally characterized using this method. FIG. 1 through 4 show the Raman spectra of CoTMPP/KBr specimens treated in the low-temperature plasma at different plasma powers (80 W-400 W at 20 min treatment duration using inert Ar plasma gas) in comparison to untreated CoTMPP/KBr specimens (normalized intensity of the reflected light plotted over the Raman shift as a function of the exciting laser light in cm⁻¹).

The typical Raman bands of the untreated CoTMPP/KBr reaction batch were observed again in the spectrum of the specimen treated at a low plasma power (80 W). The bands of the untreated specimen and of the specimen treated in the low-temperature plasma are indicated in the following table. The vibrations are assigned in accordance with the dissertation by M. Stelter “Elektrolytische Sauerstoffreduktion an übergangsmetallporphyrinmodifizierten Graphitelektroden”, TU Chemnitz, 2002, Chapter 2, pp. 11-41.

| | Band in the spectrum | Band in the spectrum |
|---|---|---|
| | of the plasma-treated | of the untreated |
| Vibration | specimen [cm⁻¹] | specimen [cm⁻¹] |
| asymmetric (1/2) pyrrole | 1016 | 1014 |
| ring vibration | | |
| asymmetric C—H | 1070 | 1073 |
| deformation | | |
| methoxyphenyl | 1178 | 1174 |
| methoxy and phenyl | 1250 | 1241 |
| band as substituent | | |
| C-phenyl | 1285 | 1289 |
| (in the plane) C—C | 1351 | 1354 |
| vibration and C—H | | |
| deformation | | |
| symmetric (1/2) pyrrole | 1366 | 1368 |
| ring vibration and C—N | | |
| vibration | | |
| C—C vibration | 1466 | 1467 |
| asymmetric C—C | 1498 | 1505 |
| vibration | | |
| (in the plane) C—C | 1539 | 1544 |
| vibration | 1560 | 1562 |
| phenyl | 1599 | 1597 |

The occurrence of these discrete narrow bands reveals that, at this power, a very large concentration of unreacted porphyrin molecules is present. However, in the case of the specimens treated in the low-temperature plasma at 80 W (Raman spectrum in accordance with FIG. 1), overlapping broad bands are additionally formed in the region between 1200 and 1350, as well as between 1400 and 1600. In response to higher plasma energy, these bands increase in width and intensity, as is discernible in the spectrum of those specimens treated at a plasma power of 150 W (Raman spectrum in accordance with FIG. 2). Deconvolution of the spectrum (150 W) reveals that these signals are constructed from bands of different widths. The broadening of the bands indicates that the specimen is no longer made up of discrete molecules, but rather is a mixture of a plurality of molecular-like bonds. At 1600 cm⁻¹ and 1340 cm⁻¹, one observes the characteristic bands for the planar vibration of expanded graphene planes, as described in the related art (compare Tuinstra, F. and Koenig, J. L., “Raman Spectrum of Graphite,” The Journal of Chemical Physics, 33, 1126 (1970)) (G band, 1600 cm⁻¹) and the fracture edges thereof (D bands, 1340 cm⁻¹). However, at 150 W, the proportion of these bands in the total spectrum is still very small, which indicates a very small proportion of graphene planes in the specimen. At a higher plasma power (250 W, 400 W), the proportion of these bands increases considerably (Raman spectra in accordance with FIGS. 3 and 4), which is indicative of the progressive carbonization of the porphyrin.

At 150 W, an intensive broad band is also observed at 1250 cm¹, which is assigned to sp2-hybridized carbon in low-molecular bonds. In this case, it is a question of fragments of the porphyrin disintegrated by the low-temperature plasma that have not yet reorganized themselves into graphene planes. With increasing plasma power (250 W, 400 W, Raman spectra in accordance with FIGS. 3 and 4), the proportion of these species in the specimen drops considerably, since, at this point, these fragments have largely been consumed for the formation of graphene planes. In addition, at 150 W (Raman spectrum in accordance with FIG. 2), a dominant band is observed at 1510 cm⁻¹, which indicates a superposition of Raman-active intermediate products of unknown structure. This is borne out by the fact that the proportion of this signal, together with the signal at 1250 cm⁻¹, decreases considerably with increasing plasma power. It is evident that, at 150 W, besides small quantities of carbon, an intermediate product of the plasma treatment is provided, which is finally transformed into graphene structures at higher plasma powers. In these experiments, no further change in the material is observed in the Raman spectrum between the specimens treated at 250 W and 400 W (Raman spectra in accordance with FIGS. 3 and 4).

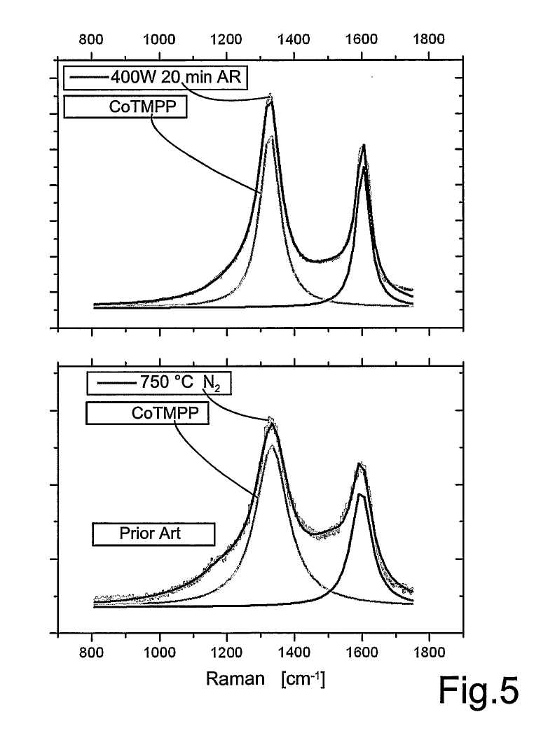

The comparison of the Raman spectra of a thermally treated CoTMPP specimen (750° C., current of N₂ without carbon support material, FIG. 5, below) and of a plasma-treated CoTMPP/KBr specimen (400 W, 20 min Ar, FIG. 5, above; the untreated CoTMPP specimen is also shown in both Raman spectra for comparison purposes) reveals that the products obtained by the pyrolysis and the plasma treatment according to the present invention have the same characteristic. In conclusion, it is apparent that, at high plasma powers (400 W), a carbon structure obtained by the plasma treatment of CoTMPP is similar to that produced in the thermal treatment. At or above 250 W, a complete carbonization of the material used results. However, at a high plasma power (400 W), the reaction is completed more quickly.

### Electrochemical Characterization of the Plasma-Treated Chelate Catalyst Material

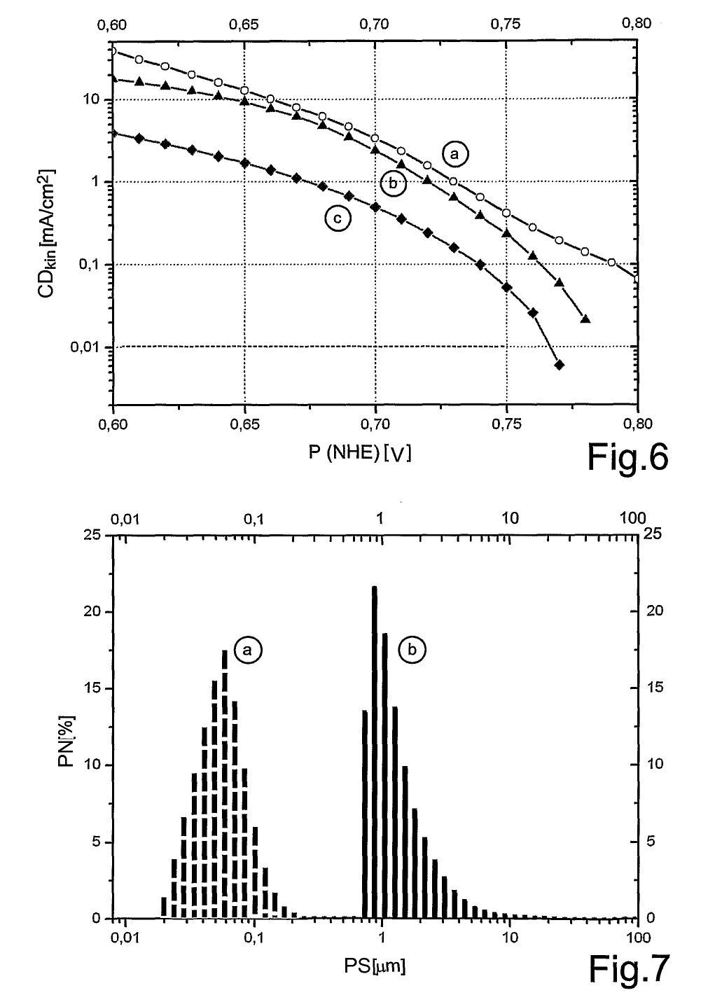

1 mg of the chelate catalyst material obtained using the two different methods is mixed with 200 ml of a 0.2% ethanol Nafion solution and suspended for 30 min in the ultrasonic bath. 5 μl of this suspension are pipetted onto a polished glassy carbon electrode having a diameter of 3 mm and dried by exposure to air. The thus prepared working electrode is measured in an electrochemical measuring cell in a three-electrode configuration using a mercury sulphate electrode as a reference electrode and a platinum wire as a counterelectrode in 0.5 M H₂SO₄ solution as electrolyte in O₂-saturated solution. The diffusion-corrected current densities are plotted as a function of the potential across the working electrode (kinetic current density CDₖᵢₙ in mA/cm² as a function of the potential as compared to a normal hydrogen electrode P(NHE) in V) in the diagram in accordance with FIG. 6, in the comparison between the plasma-treated starting material (plasma-treated specimen (circles, curve a), 400 W, 20 min, argon) and thermally treated starting material (reference specimen (triangles, curve b), thermal treatment). As a comparison, the performance characteristics of the untreated starting material (rhombi, curve c) are also shown.

Clearly discernible are the especially favorable performance characteristics of the plasma-treated chelate catalyst material according to the present invention as compared to the two other specimens. The untreated starting material exhibits a very low current density. In contrast, the treated specimens exhibit higher current densities than the starting material. Compared to the reference specimen from the thermal treatment, the plasma-treated material shows substantially higher current densities. The following table contrasts the current densities attained for various potentials:

| | potential (NHE) [V] | | | | | | |
|---|---|---|---|---|---|---|---|
| | 0.60 | 0.62 | 0.65 | 0.67 | 0.70 | 0.72 | 0.75 |
| kinetic current density | 17.83 | 14.42 | 9.28 | 6.16 | 2.38 | 1.01 | 0.23 |
| reference (thermal | | | | | | | |
| treatment) [mA/cm²] | | | | | | | |
| kinetic current density | 38.90 | 25.14 | 12.78 | 7.99 | 3.35 | 1.56 | 0.42 |
| plasma-treated | | | | | | | |
| material (400 W | | | | | | | |
| 20 min argon | | | | | | | |
| plasma) [mA/cm²] | | | | | | | |
| difference between | 21.07 | 10.72 | 3.50 | 1.83 | 0.97 | 0.55 | 0.19 |
| reference and plasma- | | | | | | | |
| treated material | | | | | | | |
| [mA/cm²] | | | | | | | |

In addition, gas sorption measurements based on the BET model are performed to determine the specific surface area. The reference specimen has a specific surface area of 1,047 m²/g. A specific surface area of 693 m²/g was determined for the plasma-treated specimen. Although the plasma-treated specimen has a lower specific surface area, it presents higher kinetic current densities than the reference specimen. In this context, it becomes apparent that the chelate catalyst prepared in the plasma treatment has a higher specific activity than the chelate catalyst prepared using the conventional method.

### Characterization of the Plasma-Treated Chelate Catalyst Material Particles

The particle-size distribution of the catalyst particles is determined with the aid of laser diffraction measurement methods. The diagram in accordance with FIG. 7 illustrates the measured particle-size distributions of the reference specimen and of the plasma-treated chelate catalyst material (particle number PN in % over particle size PS in μm). The largest proportion of the particles of the reference specimen (solid lines, b) has a particle size of approximately 0.87 μm. In contrast, particles of only approximately 0.06 μm are produced in the plasma treatment (dashed lines, a).

In response to the heat input during the thermal treatment known from the related art (compare Tuinstra, F. and Koenig, J. L., “Raman Spectrum of Graphite,” The Journal of Chemical Physics, 33, 1126 (1970)), the CoTMPP melts at approximately 390° C. The formation of the liquid CoTMPP film leads to sintering of the particles during the melting, forming aggregates whose size has a disadvantageous effect on the preparation of gas diffusion electrodes, for example. In contrast, in the plasma treatment according to the present invention, the sintering action is prevented since predominantly electronic energy and only a small amount of heat are input during the plasma treatment, thereby largely preventing a melting of the CoTMPP and sintering of the particles. The result is the formation of small particles, which is a prerequisite for preparing efficient electrodes (for example, porous gas-diffusion electrodes).

### Producing a Coating Using a Combined Sputtering and Plasma Technology for a Gas-Diffusion Electrode Application

First, a sputtering target of CoTMPP is prepared. To this end, approximately 15 g of CoTMPP are pressed into a 94.5 cm round copper target using a hydraulic press (3 t, 3 times 10 min). Smaller targets, which make it possible to economize on material, may also be used when the sputtering system includes a magnetron. The target produced is mounted in the sputtering system, allowing it to be used as an electrode. In this context, the target is suspended opposite a substrate for producing the gas-diffusion electrode (substrate: carbon paper). To begin with, the sputtering system is rinsed with argon, and an operating pressure of approximately 10 Pa argon is ultimately adjusted.

The plasma is subsequently initialized by application of a voltage and ignited by radio frequency excitation. The following operating parameters are in accordance with one embodiment of the sputtering process: low-temperature plasma, argon as inert plasma gas, pressure 10 Pa, plasma power for the first low-temperature plasma treatment less than 100 W (for the sputtering process), plasma power for the second low-temperature plasma treatment greater than 250 W (for the plasma process); a two-zone plasma is used between the two plasma treatments, or a switch is made in an alternating process (the switching frequency may be in the kHz to the mHz range); during the plasma process, the sputtering target is protected from carbonization (total process duration up to 60 min). The thickness of the catalyst layer may be determined as a function of the loading of the carbon paper. The coated carbon paper may subsequently be processed into a membrane electrode assembly (in short: MEA). In addition, a polymer electrolyte membrane, for example Nafion, may also be used as a substrate to be coated with the platinum-free chelate catalyst material according to the present invention.

Structural Characterization of the Coating as Final Product from the Platinum-Free Chelate Catalyst Material as Intermediate Product

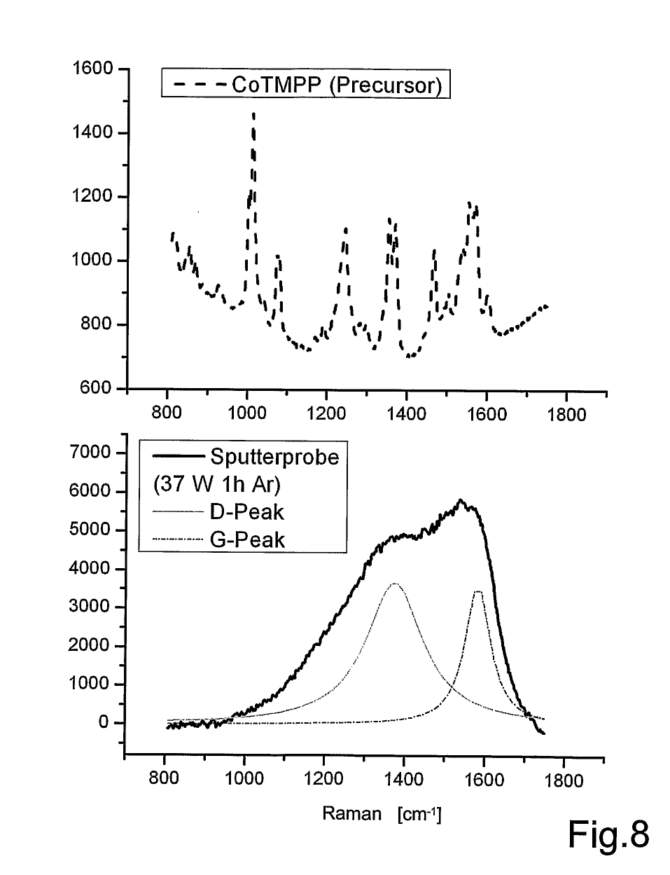

The structural characterization of the coating obtained by the method according to the present invention was carried out using Raman spectroscopy (HeNe λ=632.82 nm). In this connection, a carbon-free, Raman-inactive substrate (DC plate silica gel) was used. A combined sputtering plasma process was carried out. FIG. 8 shows the Raman spectra of the original precursor (CoTMPP) and of the specimen from the combined sputtering plasma process. The precursor shows the typical Raman bands of CoTMPP, as described in M. Stelter. In contrast, it is not possible to detect these Raman spectrum bands again in the specimen obtained from the combined sputtering plasma process. Instead, the specimen shows two bands observed by peak deconvolution at approximately 1,365 cm⁻¹ and 1,575 cm⁻¹, which are known from the related art and are typical for black carbons. The peak at approximately 1,575 cm⁻¹ (the so-called G peak) is assigned to sp²-hybridized C—C vibrations of the graphene planes, while the peak at 1,365 cm⁻¹ (D peak) is caused by carbon atoms at the edge position. Because the Raman bands of the precursor are no longer discernible, but the typical peaks of graphene planes are observed, it is demonstrated that the precursor used in the sputtering target is fully converted by the second plasma process into a carbon-based catalyst (“carbonized chelate catalyst material”).

Characterization of the Coating as Final Product from the Platinum-Free Chelate Catalyst Material as Intermediate Product

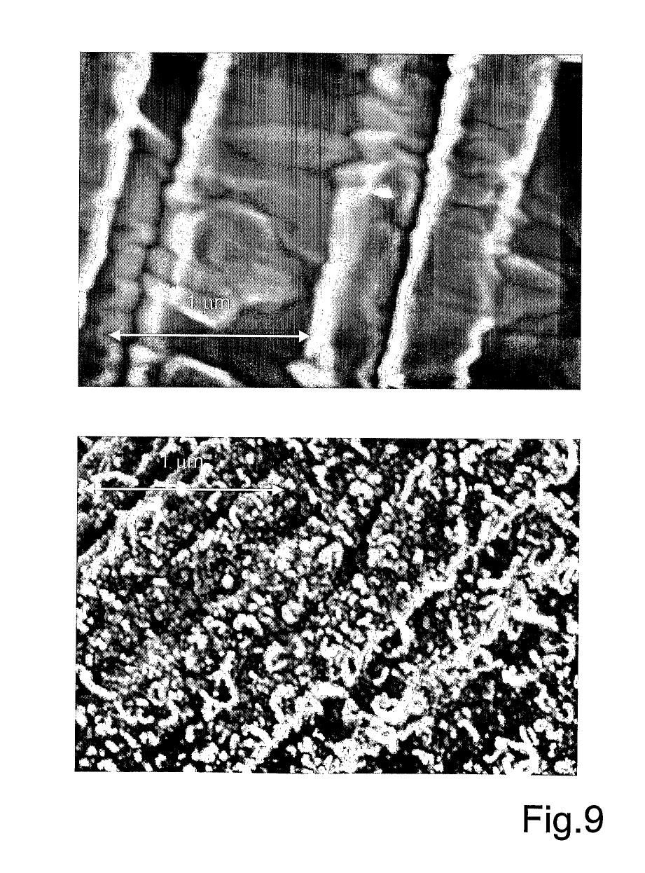

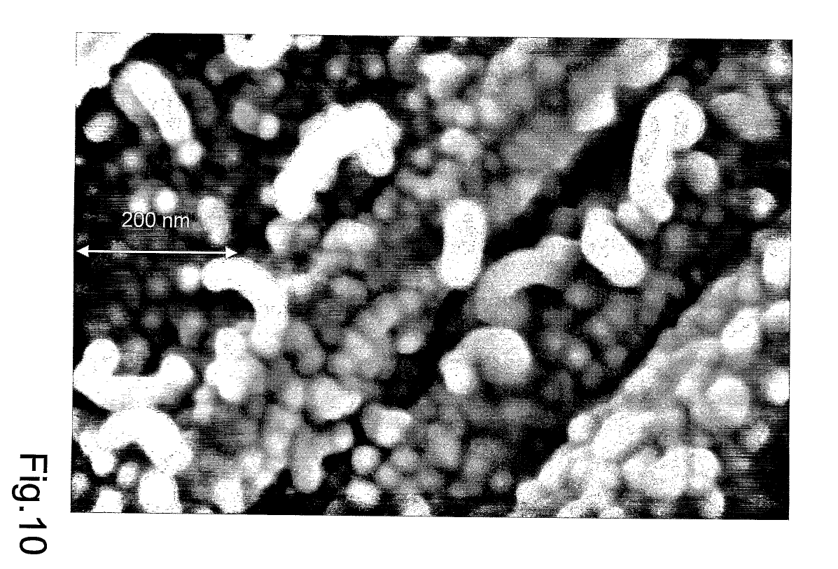

For the morphological characterization of the structure produced on the electrode, an electrically conductive carbon paper is used as a substrate. The electrode was produced, in turn, in accordance with the combined sputtering plasma process. The REM photographs (FIG. 9) show the surface of the carbon paper before (top) and after (bottom) the treatment. While before the process is carried out, the carbon fibers of the carbon paper still have a smooth surface, after the process, deposited particles having a nanoporous structure are observed on the carbon fibers. The higher resolution REM photograph (FIG. 10) clearly reveals that the deposited particles are spherical and approximately 20 to 50 nm in size. The resulting nanostructure made up of the particles constitutes a highly electrochemically active surface which forms the basis for a high catalytic activity.

Because the particle sizes are on the order of commercial platinum catalysts, as are used in fuel cells, the materials obtained using this method may also be used in established methods to produce gas-diffusion electrodes for PEM fuel cells.

1-10. (canceled)

11: A method for preparing a platinum-free chelate catalyst material as an intermediate product for selective electrocatalytic reduction of oxygen, the catalyst material including a porous conductive carbon matrix having embedded electrochemically active centers of a transition-metal chelate, the method comprising:
performing a low-temperature plasma treatment on a powdery form of the transition-metal chelate in a plasma reactor chamber having an inert plasma gas disposed therein; and
selecting a plasma power, a plasma gas pressure, a plasma initialization and a treatment time of the low-temperature plasma treatment so that molecules of the transition metal chelate are fragmented in the plasma and cross-link in a subsequent chemical reaction so as to form the carbon matrix and retain a basic chelate structure in a surrounding of the transition metal.

12: The method as recited in claim 12 wherein:
the gas pressure in the plasma reactor chamber is about 10 Pa;
the plasma initialization is in response to frequency excitation within a radio frequency range;
the plasma power is more than 250 W; and the treatment time is between 5 and 20 minutes.

13: The method as recited in claim 1 further comprising providing carbon as a substrate medium for the powdery transition metal chelate.

14: The method as recited in claim 11 wherein the transition metal chelate is CoTMPP.

15: The method as recited in claim 11 wherein the inert plasma gas is argon.

16: A method for making an electrocatalytic coating on a substrate for selective electrocatalytic reduction of oxygen, the coating including a platinum-free chelate catalyst material having a porous conductive carbon matrix with embedded electrochemically active centers of a transition-metal chelate, the method comprising:
performing a first low-temperature plasma treatment on a sputtering target made of the transition-metal chelate in a plasma reactor chamber having an inert plasma gas disposed therein;
selecting a plasma power, a plasma gas pressure and a plasma initialization of the first low-temperature plasma treatment so that molecules of the transition metal chelate are released and pass over into the plasma without being fragmented;
performing, in the plasma reactor chamber, a second low-temperature plasma treatment of the released unfragmented molecules of the transition metal, the plasma reactor chamber having the inert plasma gas disposed therein;
selecting a plasma power, a plasma gas pressure, a plasma initialization and a treatment time of the second low-temperature plasma treatment so that molecules of the released unfragmented molecules of the transition metal chelate are fragmented in the plasma and cross-link in a subsequent chemical reaction so as to form the carbon matrix and retain a basic chelate structure in a surrounding of the transition metal; and
performing a deposition, onto the substrate, of the platinum-free chelate catalyst material prepared in the second low-temperature plasma treatment.

17. The method as recited in claim 16 wherein the first and the second plasma treatments are each performed at least once in alternating fashion, and further comprising protecting the sputtering target during the second plasma treatment.

18: The method as recited in claim 16 wherein the first and the second plasma treatments are performed a plurality of times alternatingly at a frequency within a kHz to mHz range.

19: The method as recited in claim 16 wherein the first and the second plasma treatments are performed in parallel in respective separate regions of the plasma reactor chamber.

20: The method as recited in claim 16 wherein
the plasma gas pressure of the first plasma treatment is about 10 Pa;
the plasma initialization of the first plasma treatment is in response to frequency excitation within a radio frequency range; and
the plasma power of the first plasma treatment is less than 150 W.

21: The method as recited in claim 16 wherein:
the plasma gas pressure of the second plasma treatment is about 10 Pa;
the plasma initialization of the second plasma treatment is in response to frequency excitation within a radio frequency range;
the plasma power of the second plasma treatment is more than 250 W; and
the treatment time of the second plasma treatment is between 5 and 20 minutes.

22: The method as recited in claim 16 wherein the substrate is made of carbon.

23: The method as recited in claim 16 wherein the transition metal chelate is CoTMPP.

24: The method as recited in claim 16 wherein the inert plasma gas is argon.

25: The method as recited in claim 16 further comprising disposing the substrate within the plasma of the second low temperature plasma treatment.

26: The method as recited in claim 16 wherein the performing of the first and second low-temperature plasma treatments are performed as part of an automated in-line process.

27: A method for making an electrocatalytic coating on a substrate, the coating including a platinum-free chelate catalyst material having a porous conductive carbon matrix with embedded electrochemically active centers of a transition-metal chelate, the method comprising:
performing a first low-temperature plasma treatment on a sputtering target made of the transition-metal chelate in a first plasma reactor region having an inert plasma gas disposed therein;
selecting a plasma power, a plasma gas pressure and a plasma initialization of the first low-temperature plasma treatment so that molecules of the transition metal chelate are released and pass over into the plasma without being fragmented;
performing, in a second plasma reactor region separate from the first plasma reactor region, a second low-temperature plasma treatment of the released unfragmented molecules of the transition metal, the plasma reactor region having the inert plasma gas disposed therein;
selecting a plasma power, a plasma gas pressure, a plasma initialization and a treatment time of the second low-temperature plasma treatment so that molecules of the transition metal chelate are fragmented in the plasma and cross-link in a subsequent chemical reaction in such a way that the carbon matrix is formed and a basic chelate structure is retained in a surrounding of the transition metal; and
performing a deposition, onto the substrate, of the platinum-free chelate catalyst material prepared in the second low-temperature plasma treatment.

28: The method as recited in claim 27 wherein
the plasma gas pressure of the first plasma treatment is about 10 Pa;
the plasma initialization of the first plasma treatment is in response to frequency excitation within a radio frequency range; and
the plasma power of the first plasma treatment is less than 150 W.

29: The method as recited in claim 27 wherein:
the plasma gas pressure of the second plasma treatment is about 10 Pa;
the plasma initialization of the second plasma treatment is in response to frequency excitation within a radio frequency range;
the plasma power of the second plasma treatment is more than 250 W; and
the treatment time of the second plasma treatment is between 5 and 20 minutes.

30: The method as recited in claim 27 wherein the first and the second plasma treatments are performed a plurality of times alternatingly at a frequency within a kHz to mHz range.
